(19) United States
(12) Patent Application Publication
(10) Pub. No.: US 2009/0231286 A1
(43) Pub. Date: Sep. 17, 2009

(54) ACTIVE TOUCH PANEL VOLTAGE COMPENSATION CIRCUIT

(75) Inventor: Chun-Ting Kuo, Taipei County (TW)

Correspondence Address: Muncy, Geissler, Olds & Lowe, PLLC, P.O. BOX 1364, FAIRFAX, VA, 22038-1364, US

(73) Assignee: DANOTECH CO., LTD.

(21) Appl. No.: 12/046,906

(22) Filed: Mar. 12, 2008

(51) Int. Cl. G06F 3/041

(52) U.S. Cl. 345/173

(57) ABSTRACT

An active touch panel voltage compensation circuit, which is to improve voltage distribution in the border of an electrode layer of a touch panel, comprises: a power supply unit provides an initial voltage to a plurality of voltage-applying points of the electrode layer. A differential amplifier unit sets a calibration level. The differential amplifier unit is coupled to a plurality of detection points to obtain a plurality of detected voltages, and compares the detected voltages with the calibration level to obtain a plurality of deviation values. A processing unit works out the compensation voltages for the voltage-applying points according to the deviation values, generates a plurality of gain-modulation signals according to the compensation voltages and sends the gain-modulation signals to the power supply unit. The power supply unit regulates the initial voltage to the plurality of compensation voltages so that the detected voltages can reach the calibration level.

### FIELD OF THE INVENTION

The present invention relates to an active touch panel voltage compensation circuit, particularly to a circuit for the uniform voltage distribution on an electrode layer of a touch panel.

### BACKGROUND OF THE INVENTION

With the rapid development of LCD panels and the touch control technology, touch panels have been extensively used in mobile phones, information products and various exhibitions. Among them, the resistive type and capacitive type are the most widely touch panels. In a capacitive touch panel, an electrode layer is electroplated on a glass substrate, and a protection layer is formed on the electrode layer. From four corners, voltages are applied to the electrode layer to create an equipotential figure of the voltage distribution on the electrode layer. An active area is defined from the equipotential figure, and the touch panel can precisely detect the contact position inside the active area. The active area is usually a rectangle defined by the central points of the inward-concaved equipotential lines. The reason why the equipotential lines are concaved inward may be that the impedance of the panel induces the attenuation of voltage, or that the output variation of the power source (applying voltage to the electrode layer) induces the variation of the equipotential lines, or that another environmental factor induces the variation of the equipotential lines. Refer to FIG. 1 a diagram schematically showing the distribution of equipotential lines on a conventional touch panel. A power source applies voltage from several voltage-applying points to the electrode layer and makes the voltage distributed on the electrode layer. The voltage attenuates slightly from the voltage-applying points to the center of the electrode layer. The equipotential lines 13 define a rectangular area as the active area of the touch panel 1. As there is a given spacing between two voltage-applying points, voltage attenuates in between the voltage-applying points, which causes the equipotential lines 13 to recede toward the center of the touch panel 1. The equipotential line 13 is inward concaved to form an arc shape. The more far away from the voltage-applying points a section of the equipotential line 13, the more obvious the deflection. Thus, the active area of the touch panel 1 can only be a rectangle within the centers of the inward concaved equipotential lines 13. If the equipotential line 13 is concaved inward too much, the width of the non-touch control edge will be too great. Too great a non-touch control edge increases the cost and impairs the area reduction of the touch panel. Some prior arts modify the electrode layout to improve the inward-concaved equipotential lines 13. For example, a R.O.C. patent No. 1236627 disclosed “Linear Electrodes of Touch Panel”, wherein several straight segments, several protruding tips and several protruding rods, which extend toward the center, are used to improve the distribution of the equipotential lines and straighten the equipotential lines. However, the inward extension of the straight segments, protruding tips and protruding rods contrarily generates an inactive area in the perimeter of the touch panel. A U.S. Pat. No. 7,075,522 disclosed a “Touch Panel Structure for Increasing Active Area”, which also modifies the electrode layout to improve the distribution of the equipotential lines. Although the abovementioned prior arts can improve the linearity of the equipotential lines, they still have room to improve.

### SUMMARY OF THE INVENTION

One objective of the present invention is to provide a compensation circuit to regulate the voltage applied to the electrode layer of a touch panel to optimize the distribution of the equipotential lines and increase the active area of the touch panel, which can overcome the problem of the inward-concaved equipotential lines that the prior arts cannot effectively solve.

The present invention discloses an active touch panel voltage compensation circuit, which is to improve the voltage distribution along the edges of the electrode layer of a touch panel, and which comprises: a power supply unit, a differential amplifier unit, and a processing unit. The power supply unit applies an initial voltage to a plurality of voltage-applying points of the electrode layer. The differential amplifier unit sets a calibration level and is coupled to a plurality of detection points corresponding to the plurality of voltage-applying points to obtain a plurality of detected voltages. The detected voltages are compared with the calibration level to determine a plurality of deviation values corresponding to the plurality of detection points. The processing unit works out the compensation voltages for the voltage-applying points according to the deviation values, generates a plurality of gain-modulation signals according to the compensation voltages, and sends the gain-modulation signals to the power supply unit. The power supply unit regulates the initial voltage to the plurality of compensation voltages so that the voltages detected in the detection points can reach the calibration level. Thereby, the voltage attenuation between two voltage-applying points of the touch panel can be corrected. The circuit of the present invention can automatically regulate the voltages of the plurality of voltage-applying points to make the equipotential lines more close to the border of the electrode layer.

Therefore, the present invention can enlarge the active area defined by the equipotential lines and improve the accuracy of the touch panel.

### BRIEF DESCRIPTION OF THE DRAWINGS

FIG. 1 is a diagram schematically showing the distribution of the equipotential lines on a conventional touch panel.

FIG. 2 is a block diagram schematically showing a circuit according to the present invention.

FIG. 3 is a diagram schematically showing the distribution of the equipotential lines on the touch panel with the circuit of the present invention.

### DETAILED DESCRIPTION OF THE PREFERRED EMBODIMENTS

Below, the technical contents of the present invention will be described in detail in cooperation with the drawings.

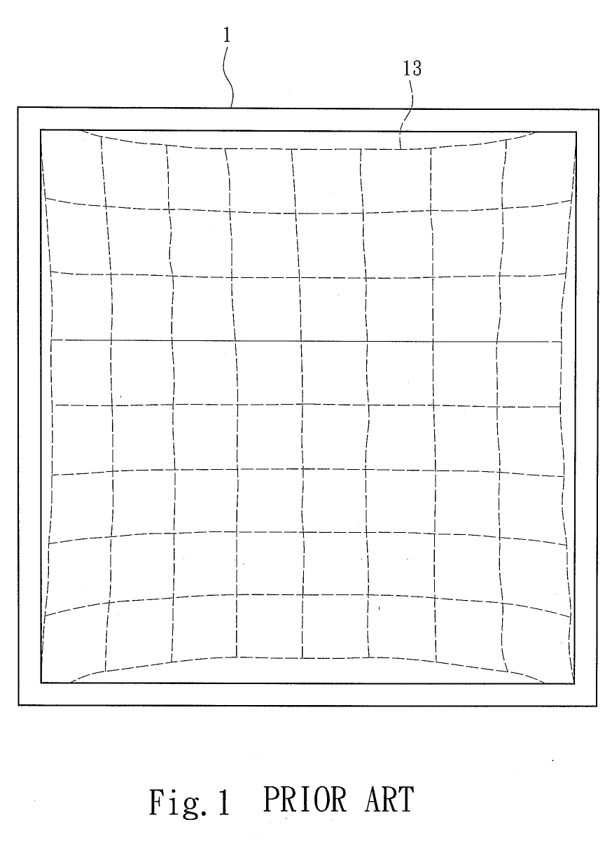

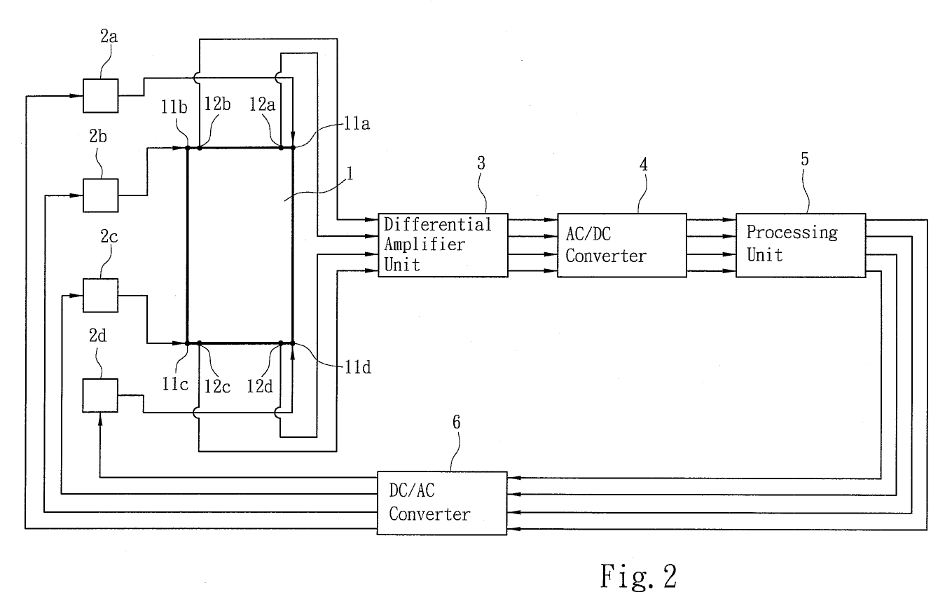

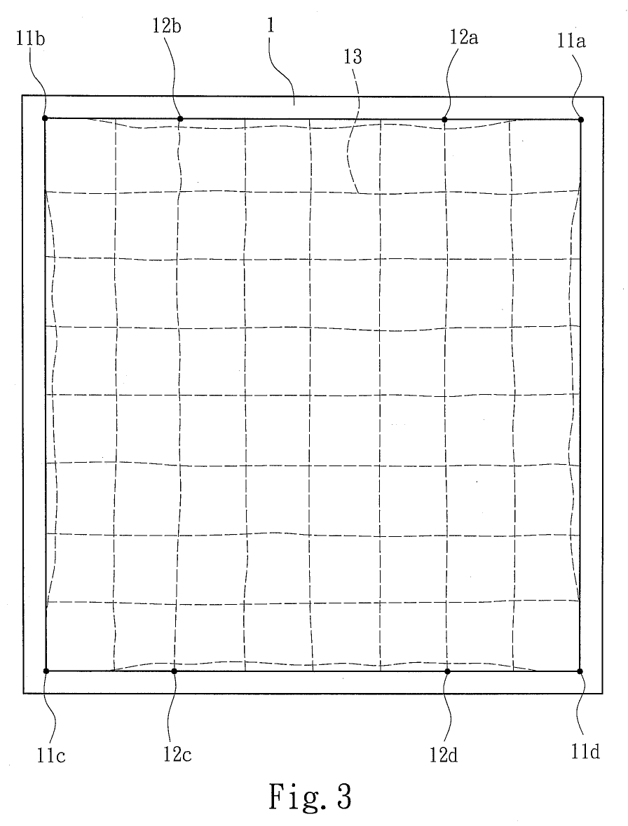

The present invention is an active touch panel voltage compensation circuit, which is to improve the voltage distribution of a touch panel. Refer to FIG. 2 a block diagram schematically showing a circuit according to the present invention. There is a plurality of voltage-applying points in a touch panel 1, and there are four voltage-applying points 11a, 11b, 11c and lid in this embodiment. The circuit of the present invention comprises: a power supply unit, a differential amplifier unit 3 setting a calibration level, and a processing unit 5 calculating the output of the power supply unit. The power supply unit further comprises a plurality of voltage gain circuits 2a, 2b, 2c and 2d, which respectively control the voltages output to the plurality of voltage-applying points 11a, 11b, 11c and lid. The voltage-applying points 11a, 11b, 11c and lid provide an initial voltage to start the touch panel 1. A plurality of detection points 12a, 12b, 12c and 12d is respectively arranged besides the corresponding voltage-applying points 11a, 11b, 11c and lid. The differential amplifier unit 3 is coupled to the plurality of detection points 12a, 12b, 12c and 12d to obtain a plurality of detected voltages and compares the detected voltages with the calibration level to obtain a plurality of deviation values. An AC/DC converter 4 is arranged in between the differential amplifier unit 3 and the processing unit 5 to convert the deviation values into digital signals. The processing unit 5 works out the compensation voltages for the voltage-applying points 11a, 11b, 11c and 11d according to the deviation values and generates a plurality of gain-modulation signals according to the compensation voltages. A DC/AC converter 6 converts the gain-modulation signals into analog signals and sends the analog signals to the voltage gain circuits 2a, 2b, 2c and 2d to make the voltage gain circuits 2a, 2b, 2c and 2d regulate the initial voltage to the plurality of compensation voltages to adjust the voltages applied to the voltage-applying points 11a, 11b, 11c and lid so that the voltages detected in the detection points 12a, 12b, 12c and 12d can reach the calibration level. Once the voltages detected in the detection points 12a, 12b, 12c and 12d can reach the calibration level, the voltage attenuation-induced deviations neighboring the voltage-applying points 11a, 11b, 11c and lid are corrected to near ideal values so that equipotential lines 13 (shown in FIG. 3) of the touch panel 1 can get closer to the border of the electrode layer of the touch panel 1 lest the equipotential lines 13 be too much inward concaved and the active area of the touch panel 1 be decreased. Refer to FIG. 3 a diagram schematically showing the distribution of the equipotential lines of the touch panel with the circuit of the present invention. Via comparing FIG. 3 with FIG. 1, it is found that the present invention can effectively improve the distribution of the equipotential lines 13 of the touch panel 1, make the equipotential lines 13 get closer to the border of the electrode layer of the touch panel 1, and thus increase the active area of the touch panel 1. Thereby, the accuracy of touch control can also be promoted. The present invention uses feedback signals to automatically detect deviations and calculate the compensation voltages to correct the deviations no matter whether the deviations result from the output variation of the power supply or the impedance variation of the touch panel 1 or another factor. Thus, the present invention can save maintenance personnel a lot of examination and correction time.

The abovementioned deviation values may be proportional to or inversely proportional to the compensation voltages. The differential amplifier unit 3 may further comprise a differential amplifier and a multiplex switch. The multiplex switch sequentially conducts the detected voltages to the differential amplifier so that the differential amplifier can sequentially generate the plurality of deviation values. Alternatively, the differential amplifier unit 3 comprises a plurality of differential amplifiers corresponding to the plurality of detection points 12a, 12b, 12c and 12, and the differential amplifiers simultaneously generate the plurality of deviation values. The processing unit 5 receiving the plurality of deviation values is a multiplex processor.

The preferred embodiments described above are only to exemplify the present invention but not to limit the scope of the present invention. Therefore, any equivalent modification or variation made by the persons skilled in the art according to the spirit of the present invention is to be also included within the scope of the present invention, which is based on the claims stated below.

From the above discussion, the present invention is proved to have improvements over the prior arts. Therefore, the present invention indeed possesses novelty and non-obviousness and meets the condition for a patent. Thus, the Inventors file the application for a patent. It will be appreciated if the patent is fast approved.

What is claimed is:

1. An active touch panel voltage compensation circuit, which is to improve voltage distribution in the border of an electrode layer of a touch panel, comprising:
a power supply unit providing an initial voltage to a plurality of voltage-applying points to start said touch panel;
a differential amplifier unit setting a calibration level, coupled to a plurality of detection points respectively arranged besides corresponding said voltage-applying points to obtain a plurality of detected voltages, and comparing said detected voltages with said calibration level to obtain a plurality of deviation values; and
a processing unit working out compensation voltages for said voltage-applying points according to said deviation values, sending a plurality of gain-modulation signals to said power supply unit according to said compensation voltages to make said power supply unit regulate said initial voltage to the plurality of said compensation voltages and make voltages detected in said detection points reach said calibration level, so that voltage attenuation-induced deflections between two said voltage-applying points are corrected.

2. The active touch panel voltage compensation circuit according to claim 1, wherein said deviation value is proportional to said compensation voltage.

3. The active touch panel voltage compensation circuit according to claim 1, wherein said deviation value is inversely proportional to said compensation voltage.

4. The active touch panel voltage compensation circuit according to claim 1, wherein said power supply unit further comprises a plurality of voltage gain circuits, which respectively control voltages output to the plurality of said voltage-applying points.

5. The active touch panel voltage compensation circuit according to claim 1, wherein an AC/DC converter is arranged in between said differential amplifier unit and said processing unit.

6. The active touch panel voltage compensation circuit according to claim 1, wherein said differential amplifier unit further comprise a differential amplifier and a multiplex switch; said multiplex switch sequentially conducts said detected voltages to said differential amplifier, and said differential amplifier sequentially generate the plurality of said deviation values.

7. The active touch panel voltage compensation circuit according to claim 1, wherein said differential amplifier unit comprises a plurality of differential amplifiers corresponding to the plurality of said detection points, and the plurality of said differential amplifiers simultaneously generates the plurality of said deviation values.

8. The active touch panel voltage compensation circuit according to claim 7, wherein said processing unit receiving the plurality of said deviation values is a multiplex processor.
